(19) United States
(12) Patent Application Publication
(10) Pub. No.: US 2007/0125561 A1
(43) Pub. Date: Jun. 7, 2007

(54) Soil working apparatus

(76) Inventor: Marcel Depault, St-Simon-de-Bagot (CA)

Correspondence Address: OGILVY RENAULT LLP, 1981 MCGILL COLLEGE AVENUE, SUITE 1600, MONTREAL, QC, H3A2Y3, CA

(21) Appl. No.: 11/281,505

(22) Filed: Nov. 18, 2005

(51) Int. Cl. A01B 13/08

(52) U.S. Cl. 172/699

(57) ABSTRACT

A soil working apparatus comprises a first structure moveable above a soil surface along a travel direction and a plurality of second structures connected to the first structure in a spaced apart manner along a direction substantially perpendicular to the travel direction. Each second structure pivotally supports at least one knife selectively pivotable about a substantially vertical axis between a plurality of pivoted positions. A locking mechanism locks the knife(s) of each of the second structures in a selected one of the pivoted positions. The selected pivoted position for the knife(s) of each of the support structures is independent of the selected pivoted position for the knife(s) of other support structures.

### BACKGROUND OF THE INVENTION

1. Field of the Invention

The present invention relates to agricultural equipment, particularly to soil working tools.

2. Background Art

Known soil working tools generally include series of spaced apart blades extending around a horizontal shaft which is rotatably supported on each end, with generally two such shafts supported end to end on a frame such that an angle between the two shafts can be varied. In cases where the soil working tool is used to make small linear indentations in the soil, such as when aerating, the shafts are usually used in a collinear orientation. In cases where the soil working tool is used to make wider trenches, such as when plowing, the two shafts are usually angled to form a “V” pointing forward, such as to angle the blades with respect to the direction of travel of the tool. However, in such a configuration, varying the angle of the blades with respect to the direction of travel effectively changes a distance between indentations created by the tool, which can prevent the tool from being used in a field where only the soil between existing rows of plants at a given distance from each other needs to be worked. In addition, a small number of bearings support the stress of all the tools of a same shaft, which can lead to increased failure of the bearings. Since a good number of blades extend around a same horizontal shaft and as such are disposed along a straight line with respect to one another, when such a tool is used on uneven ground, some blades can penetrate the soil deeper than others, and in some cases some blades do not penetrate the soil at all. As a result, the indentations or trenches produced in the soil can have variable depth, with some patches of the soil having no indentation at all defined therein.

When distributing liquid fertilizer on a field, it is customary to dig small linear trenches to place the fertilizer therein, in order to reduce fertilizer emissions to the atmosphere and as such reduce the propagating odor. A tool is generally used to dig the trenches and the liquid in then distributed within the trenches, either with a separate apparatus or with hoses supported on the back of the trench-digging tool. However, since the liquid distributed in the trenches is still relatively exposed to the atmosphere, the odor released is usually still problematic.

Accordingly, there is a need for an improved farm implement for working the soil and distributing liquid fertilizer.

### SUMMARY OF INVENTION

It is therefore an aim of the present invention to provide an improved soil working tool.

It is a further aim of the present invention to provide an improved combined soil working tool and liquid distributor.

Therefore, in accordance with an aspect of the present invention, there is provided a soil working apparatus comprising: a first structure movable above a soil surface along a travel direction, a plurality of laterally spaced-apart soil working tools distributed along the first structure, at least some of said soil working tools being angularly adjustable relative to said first structure between a first configuration wherein said soil working tools are substantially parallel to one another and a second configuration wherein a series of V-shaped oriented pairs of soil working tools is formed along said first structure, each V-shaped oriented pair of soil working tools defining an apex pointing in one of said direction of travel and a direction opposite thereto.

In accordance with another general aspect of the present invention, there is provided soil working apparatus comprising: a first structure moveable above a soil surface along a travel direction; and a plurality of second structures, each second structure supporting at least one soil working tool penetrating the soil surface and adapted to be dragged therein along the travel direction upon movement of the first structure along the travel direction, each of the second structures being pivotally connected to the first structure to be independently pivotable about a respective substantially horizontal axis to vary a depth of penetration of the at least one soil working tool within the soil surface.

In accordance with another general aspect of the present invention, there is provided a combined soil working tool and fluid distributor comprising: a frame moveable above a ground surface along a travel direction; and a plurality of hollow supports connected to the frame, each of the supports carrying at least one soil working tool extending downwardly therefrom and adapted to penetrate the ground surface to create a trench therein upon movement of the frame along the travel direction, each of the hollow supports defining at least one chamber, an inlet in fluid communication with the at least one chamber, and at least one outlet in proximity of the at least one soil working tool, each of the at least one outlet being in fluid communication with a respective one of the at least one chamber, the inlet receiving a flowable product to be distributed over the ground from a source of flowable product, the at least one chamber circulating the flowable product between the inlet and the at least one outlet, and the at least one outlet distributing the liquid substantially at ground level in proximity to said at least soil working tool, the at least one soil working tool burying at least partially the flowable material beneath the ground surface upon creating the trench.

Still in accordance with a further general aspect of the present invention, there is provided a method of distributing a liquid on a field, the method including the steps of: dragging a soil working tool penetrating a ground surface of the field along a travel direction to form a trench; while dragging the soil working tool, distributing the liquid on the ground surface one of directly in front of the soil working tool and substantially over a front portion of the soil working tool, the soil working tool at least partially burying the liquid beneath the ground surface as the trench is formed.

### BRIEF DESCRIPTION OF THE DRAWINGS

Reference will now be made to the accompanying drawings, showing by way of illustration a preferred embodiment of the present invention and in which:

FIG. 1 is a perspective rear view of a combined liquid distributor and soil working tool according to a particular embodiment of the present invention;

FIGS. 2A-C are perspective rear views of alternative knives which can be used with the apparatus of FIG. 1;

FIG. 3 is a perspective rear view of part of a first support structure and of one second support structure of the apparatus of FIG. 1;

FIG. 4 is a perspective rear view of the second support structure of FIG. 3, shown with knives thereof in an angled position;

FIG. 5 is a side cross-sectional view of the second support structure of FIG. 4;

FIG. 6 is a perspective front view of the second support structure of FIG. 4, with the knives and some walls thereof omitted for improved clarity; and

FIG. 7 is a perspective rear view of a liquid distributor of the apparatus of FIG. 1.

### DESCRIPTION OF THE PREFERRED EMBODIMENTS

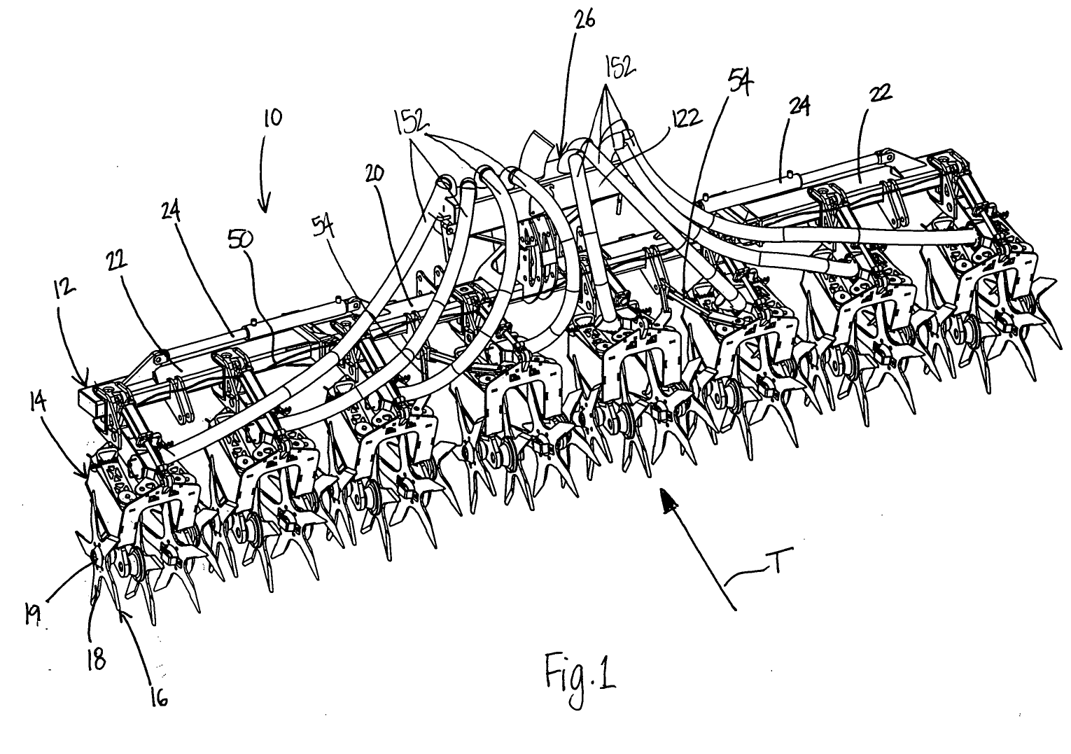

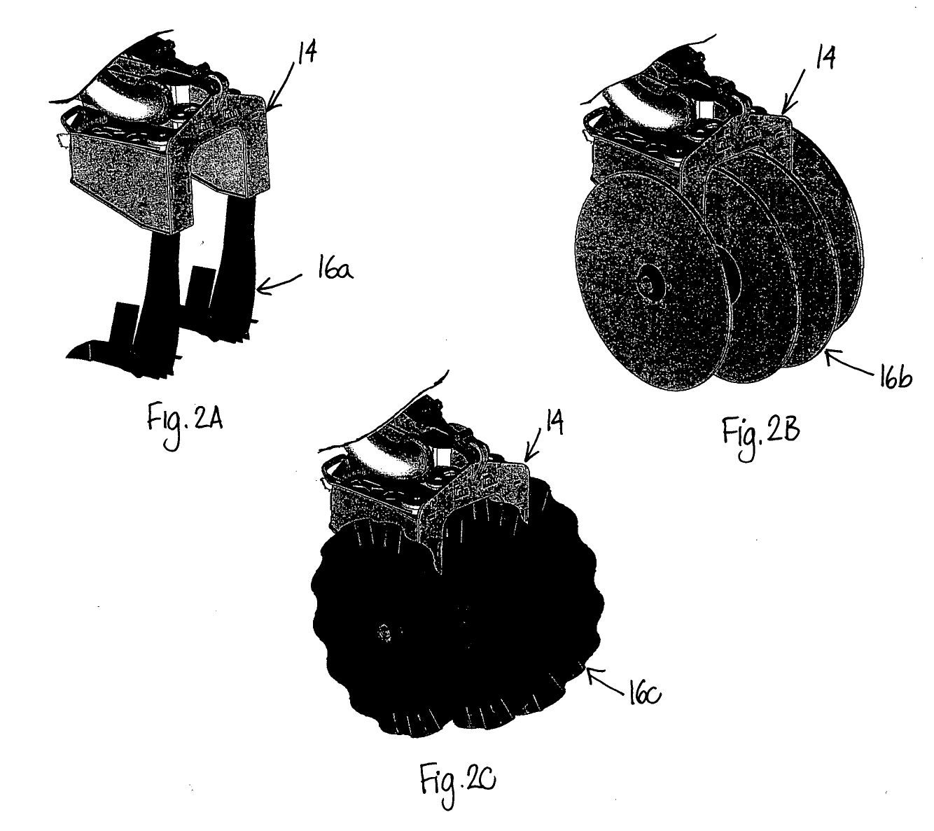

Referring now to FIG. 1, an apparatus indicated at 10, which is a combined or integrated liquid distributor and soil working tool, generally includes a first support structure 12 adapted to be pulled along a travel direction T by a motorized vehicle such as a tractor (not shown) and a series of second support structures 14 connected in a laterally spaced-apart manner along the first support structure 12, each second support structure 14 supporting at least one knife 16 adapted to penetrate a soil surface to be dragged therein as the first support structure 12 is pulled along the travel direction T. In the embodiment shown, each knife 16 includes five blades 18 extending in a star-shaped pattern around a central hub 19. Depending of the geometry of the knives 16 used, alternate examples of which are shown in FIGS. 2A-C and indicated at 16a (non-rotating elongated knife), 16b (flat disc rotating knife), 16c (corrugated disc rotating knife), the apparatus 10 can be used for example to break up soil, furrowing, aerate soil, break up roots, dig small trenches to receive fertilizer, tilling, and other types of uses.

Referring again to FIG. 1, the first support structure 12 includes a central beam 20 interconnecting two outer beams 22, all beams 20,22 extending end to end substantially horizontally and perpendicularly to the travel direction T. Each outer beam 22 is connected to the central beam 20 through an actuator 24 such as to be able to pivot the outer beams 22 upwardly about an axis substantially parallel to the travel direction T to reduce a storage space necessary for the apparatus 10, as well as a width of the apparatus 10 when being pulled. Wheels (not shown) can also be provided on the first support structure 12 to support it when being pulled but not used. The first support structure 12 also supports a liquid distributor 26 which will be described further below. Numerous alternative configurations for the first support structure 12 are possible, the one being shown in FIG. 1 being merely an example.

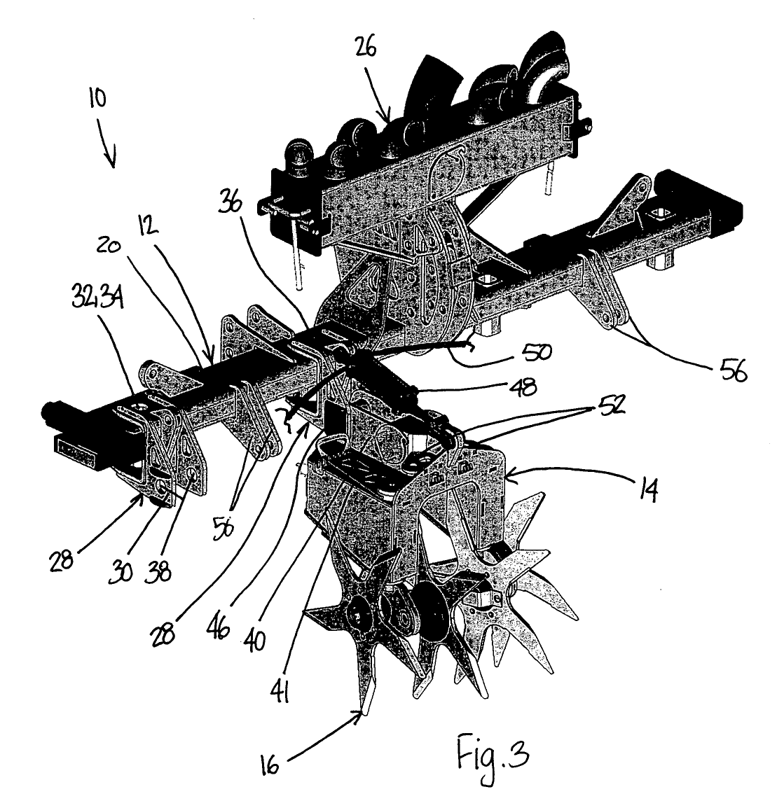

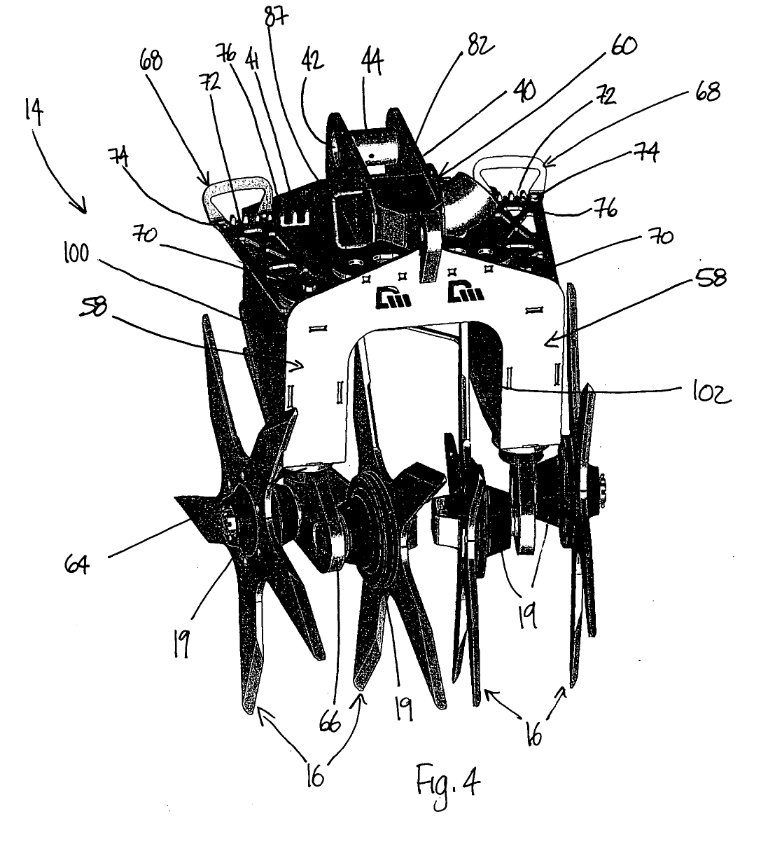

Referring to FIG. 3, the second support structures 14 (only one of which is shown) are each connected to the first support structure 12 as described in the following. For each second support structure 14, a “U”-shaped bracket 28 receives the central or outer beam 20,22 therein, and includes a pair of parallel vertical flanges 30 extending therefrom. The bracket 28 includes vertically aligned holes 32 defines therein, which are aligned with a corresponding vertical hole 34 defined in the beam 20,22, and a substantially vertical pivot 36 is inserted into the aligned holes 32,34 to pivotally interconnect the bracket 28 and the first support structure 12. The flanges 30 of the bracket 28 also include horizontally aligned holes 38 defined therein. A pair of spaced apart vertical front arms 40 extend from a top wall 41 of each second structure 14, the arms 40 extending between the flanges 30 of the bracket 28 and having horizontally aligned holes 42 defined therein (see FIG. 4) aligned with the bracket holes 38. A tubular hollow support 44 (see FIG. 4) optionally extends between the two arms 40 and defines a conduit aligned with the holes 42. A substantially horizontal pivot 46 extends through the aligned holes 38,42 and tubular support 44 to pivotally interconnect the second support structure 14 and the bracket 28. Thus, the second support structure 14 is pivotable with respect to the first support structure 12 about a substantially horizontal axis defined by pivot 46 and a substantially vertical axis defined by pivot 36.

Still referring to FIG. 3, in order for the knives 16 of all the second support structures 14 to penetrate the soil surface at substantially the same depth, an hydraulic cylinder 48 interconnects each second support structure 14 and the respective bracket 28 over the horizontal pivot 46 such that an increase in hydraulic fluid pressure within the hydraulic cylinder 48 pivots the second support structure 14 about the horizontal pivot 46 to force the knives 16 further into the ground. The hydraulic fluid pressure is counter-balanced by the resistance of the ground to the penetration of the knives 16. Hydraulic fluid lines 50 (also shown in FIG. 1) serially interconnect all the hydraulic cylinders 48, such that the hydraulic fluid is free to flow from one hydraulic cylinder 48 to another. Since the cylinders 48 are in fluid communication with one another through the hydraulic fluid lines 50, the hydraulic pressure is the same for all the hydraulic cylinders 48, thus ensuring that the depth of penetration of the knives 16 of all the second support structures 14 will be the same, even on uneven ground. Of course, other types of adequate means can be used to ensure that the pressure on all knives 16 is similar, such as, for example, electronically controlled actuators, or a precise weight pressing on each second support structures 14 in a cantilevered manner about the respective substantially horizontal pivot 46.

Further referring to FIG. 3, the pivoting action of the bracket 28 about the vertical pivot 36 prevents damage to the “U”-shaped brackets 28 and arms 40 when the apparatus 10 undergoes an abrupt turn. In linear operation however, it might be desirable to prevent the brackets 28 from pivoting about the vertical pivot 36 for the knives 16 to maintain a constant desired orientation with the travel direction T. Thus, the second support structure 14 includes two horizontal flanges 52 connected to the top thereof, one on each side, and a selected one of the flanges 52 is connected by a removable articulated rod 54 (see FIG. 1) to a corresponding vertical flange 56 extending from the first support structure 12. Thus, one rod 54 detachably interconnects each second support structure 14 to the first support structure 12, the articulated rod 54 preventing the bracket 28 and the second structure 14 from pivoting about the vertical pivot 36, but allowing the second structure 14 to pivot about the horizontal pivot 46. The rods 54 can be removed before the apparatus 10 undergoes an abrupt turn. In cases where the operation of the apparatus 10 would always produce acceptable stresses on the bracket 28 and arms 40 with the rods 54 in place, the vertical pivot 36 can be omitted from the apparatus 10 and the bracket 28 be rigidly connected to the first support structure 12, thus eliminating the need for the rods 54.

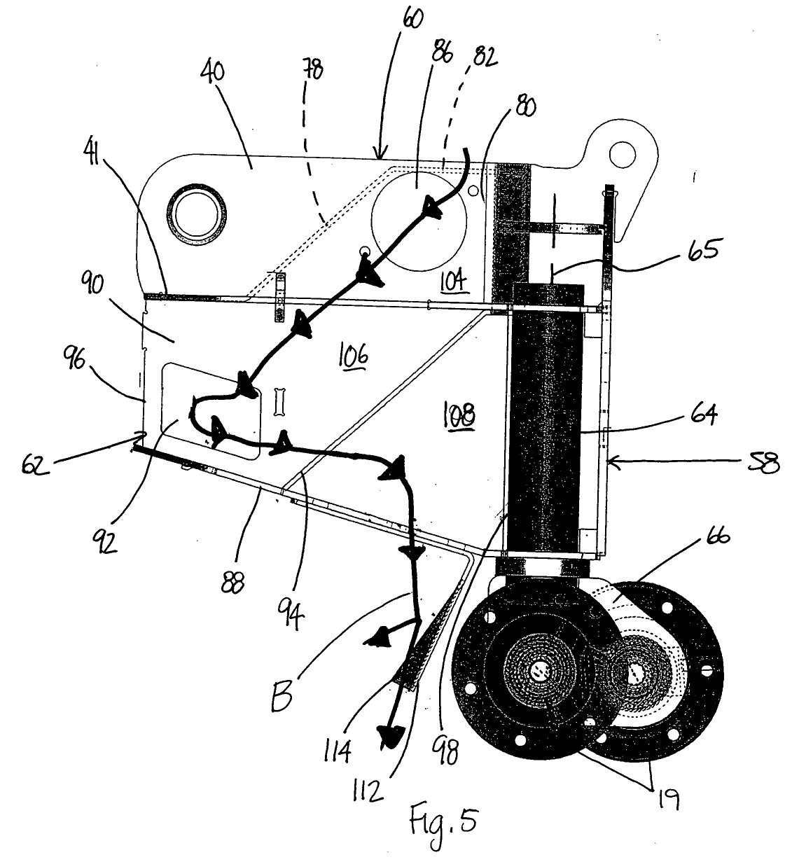

Referring to FIG. 4, each second support structure 14 generally includes two spaced apart hollow rear arms 58, interconnected by a partially hollow top portion 60 and by a hollow front portion 62 (see FIG. 5). Each of the arms 58 contains and pivotally supports a vertical shaft 64 (also shown in FIG. 5), which is pivotable about a longitudinal axis 65 thereof. Protruding downwardly from each rear arm 58, and rigidly connected to the respective shaft 64, is a vertical flange 66 rotatably supporting the hub 19 of one of the knives 16 on each side. The central axis of the hubs 19 of the knives 16 supported on the same flange 66 are horizontally offset from one another, to reduce a pressure created on the soil by adjacent knives 16 pushing the soil directly against one another. Thus, in the embodiment shown, each second support structure 14 supports four knives 16, selectively pivotable two by two by pivoting their respective shaft 64, although other configurations are also possible.

Still referring to FIG. 4, the shaft 64 also slightly protrudes upwardly of the rear arm 58, where it is keyed to one end of a handle 68. A cover 70 is attached to the top of the shaft 64, over the handle 68, to prevent the handle 68 from being disengaged from the shaft 64. The other end of the handle 68 includes a plurality of horizontally extending teeth 72 and/or holes 74. The handle 68 pivots integrally with the shaft 64 adjacent of the top wall 41 of the support structure 14. An array of vertically extending teeth 76 extend from the top wall 41, placed at a distance from the longitudinal axis 65 of the shaft 64 corresponding to a distance between the teeth/holes 72,74 of the handle 68 and the longitudinal axis 65 of the shaft 64. The teeth 76,72 are sized and spaced apart such as to be engageable to each other, and the holes 74 are sized such as to receive at least one tooth 76 therein. Thus, by pivoting the handle 68 and selectively meshing the teeth 72 and holes 74 with the teeth 76, the two knives 16 attached to the same shaft 64 are turned at a desired angle and locked in place in a desired one of a plurality of orientations. The handle 68 thus acts as a locking mechanism locking the associated knives 16 to the desired orientation.

As shown in FIG. 4, the shafts 64 of the same second support structure 14 can be oriented independently, for example to have the two pairs of knives 16 oriented toward one another. The angle of the knives 16 is selected according to the task to be accomplished with the apparatus 10. For example, in cases where the apparatus 10 is used to plough, the knives 16 can be oriented toward each other as shown in FIG. 4, replacing the general “V” shape of the blades in the prior art. The knives 16 can also be pivoted opposite of the position shown in FIG. 4, or, in cases where the apparatus 10 is used to aerate the soil, the knives 16 can be oriented parallel to one another and along the direction of travel T (see FIG. 1). A number of intermediate pivoted positions are also possible, the selected pivoted positions being selected according to the type of work to be done on the soil with the apparatus 10.

In any event, regardless of the pivoted position of the knives 16, the distance between the knives 16 of adjacent second structures 14 always remain the same, which simplifies the use of the apparatus 10 in fields where rows of plants are present to work the soil in between rows. Since the knives 16 are supported two by two, the stress produced on the hubs 19 of the knives 16 and on the supporting shaft 64 is relatively small. The individual pivoting of each shaft 64 provides for an increased number of combinations for the configuration of the knives 16 of the apparatus 10, which creates great versatility in the use of the apparatus 10.

Alternately, the shafts 64 can be rigidly supported within the arms 58, with the arms 58 being pivotable with respect to the remainder of the second support structure 14. Each knife could also be supported on an individual horizontal shaft, independently pivotally connected to the second support structure 14 about a substantially vertical axis. The knives 16 of each support structure 14 could also be rigidly supported thereon, with a locking mechanism similar to the handle 68 provided to control the pivoting motion of the bracket 28 about the substantially vertical pivot 36 or an additional similar pivot. A number of other alternate configurations allowing at least the knives 16 from different second support structures 14 to be independently pivoted are also possible.

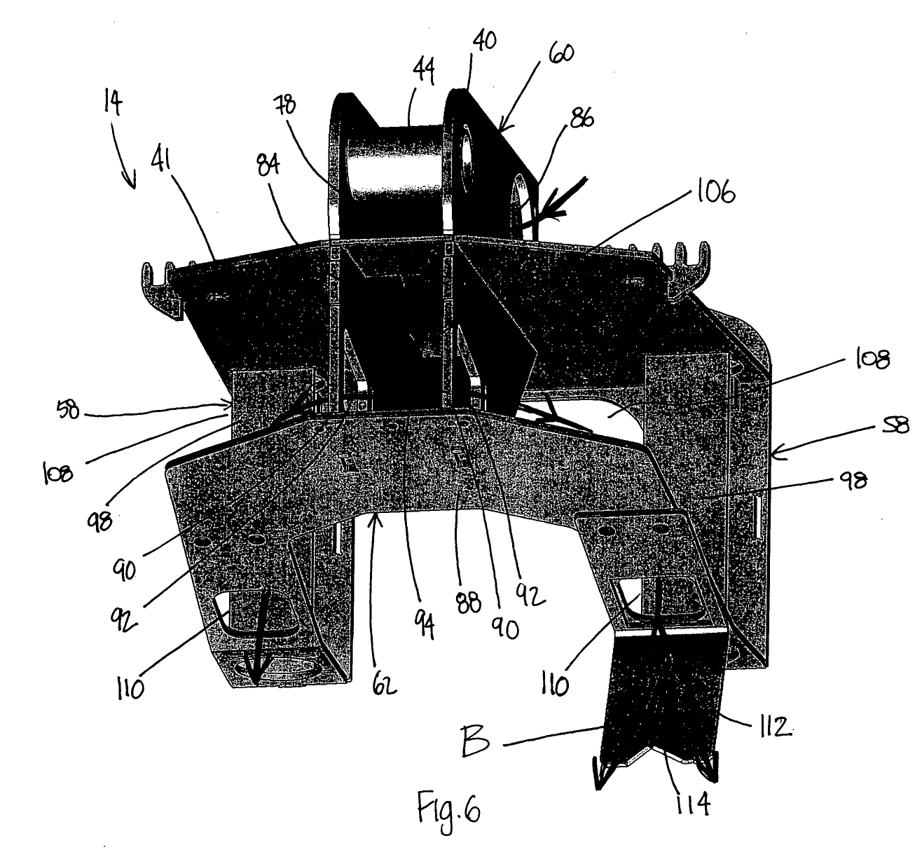

Referring to FIGS. 5 and 6, the second support structure 14 also receives and distributes a liquid, such as a fertilizer like liquid manure. The top portion 60, which includes the arms 40 and tubular support 44 described above, also includes front, rear and upper walls 78,80,82 (see FIG. 5) extending between the arms 40 rearwardly of the tubular support 44 and enclosing an opening 84 (see FIG. 6) in the top wall 41. An inlet 86 is defined in one of the arms 40 between the front and rear walls 78,80. Optionally, another inlet can be defined in the other arm 40, the unused inlet being closed by a removable plug 87 (see FIG. 4) such that the second structure 14 can interchangeably be used on either side of the apparatus 10.

A substantially “U”-shaped inclined bottom wall 88 defines the lower end of the front portion 62 and arms 58, the bottom wall 88 having a downward slope toward the rear of the second support structure 14. The front portion 62 includes two side walls 90 extending between the top and bottom walls 41,88, one side wall being located on each side of the opening 84 in the top wall 41, and each side wall 90 having an opening 92 defined therein. The front portion 62 also includes an inclined rear wall 94 extending between the two side walls 90 and the top and bottom walls 41,88, and a front wall 96 (not shown in FIG. 6 for improved clarity) also extending between the two side walls 90 and the top and bottom walls 41,88. The rear wall 94 has a downward slope toward the front of the second support structure 14.

Each arm 58 includes a partition wall 98 connecting the top and bottom walls 41,88 in front of the respective vertical shaft 64, arcuate outer walls 100 (not shown in FIG. 6 for improved clarity—see FIG. 4) connecting the top and bottom walls 41,88 from the front wall 96 to the partition wall 98, and arcuate inner walls 102 (not shown in FIG. 6 for improved clarity—see FIG. 4) connecting the top and bottom walls 41,88 from the partition wall 98 to the rear wall 94.

Still referring to FIGS. 5 and 6, a top chamber 104 (visible in FIG. 5 only) is defined in the top portion 60 between the top and upper walls 41,82, bordered by the arms 40, front wall 78 and rear wall 80, and in fluid communication with the inlet 86. A central chamber 106 is defined in the front portion 62 between the top and bottom walls 41,88, bordered by the side walls 90, inclined rear wall 94 and front wall 96, and in fluid communication with the top chamber 104 through the opening 84 in the top wall 41. A side chamber 108 is defined in each of the arms 58, between the top and bottom walls 41,88, bordered by the respective side wall 90, outer wall 100, partition wall 98 and inner wall 102, and in fluid communication with the bottom portion of the central chamber 106 through the opening 92 in the respective side wall 90. The opening 92 is spaced upwardly from the bottom wall 88 of the central chamber 106 by a weir-like wall portion to ensure an even distribution between the two side chambers 108 irrespectively of where the fluid drops on the bottom wall 88. An outlet 110 (visible in FIG. 6 only) is defined in the bottom wall 88 in proximity to each partition wall 98, in fluid communication with a respective side chamber 108. A flange 112 extends downwardly and frontwardly immediately rear of each outlet 110 to deflect fluid coming from the outlet 110 to the front and/or over the knives 16. A “V”-shaped bend 114 further deflect the outgoing liquid into two separate flows, one flow aligned with each of the two knives 16 extending from the arm 58.

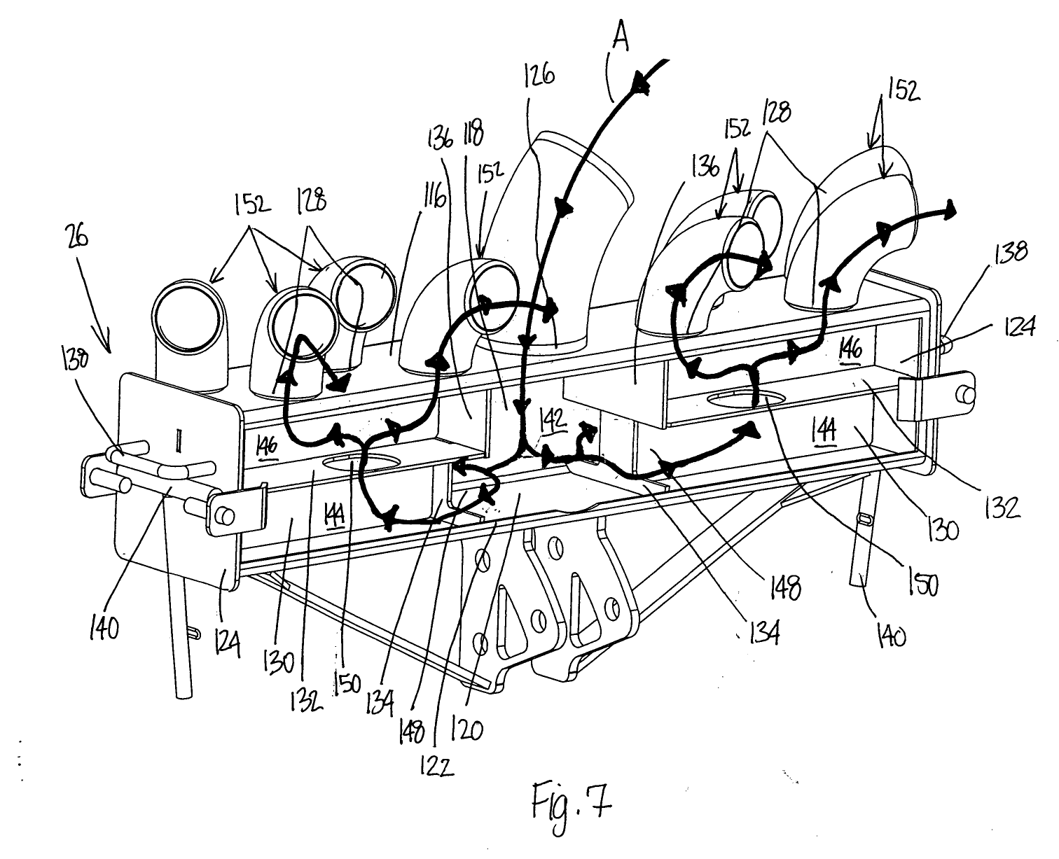

Referring to FIG. 7, the liquid distributor 26 comprises a top wall 116, a rear wall 118, a bottom wall 120, a front wall 122 (partially removed in FIG. 7 for improved clarity—see FIG. 1), and two side walls 124 which are interconnected to form a hollow, elongated box. A central inlet 126 and eight outlets 128 are defined in the top wall 116. Partitions are provided within the box to define a plurality of chambers, as described in the following. A vertical wall 130 substantially perpendicular to the top wall 116 extends from a middle thereof to a middle of the bottom wall 120, and from a respective one of the side walls 124 to about one third of the length of the distributor 26. Opposed horizontal walls 132 extend perpendicularly to and along the length of the vertical wall 130 on each side thereof, from a middle of the vertical wall 130 to a middle of a respective one of the rear and front walls 118,122. An inverted “T”-shape flange 134 vertically extends perpendicularly to the vertical wall 130 adjacent a free edge thereof from the bottom wall 120 to the horizontal walls 132. A transversal upper wall 136 extends perpendicularly to the vertical wall 130 adjacent the free edge thereof from the horizontal walls 132 to the top wall 116. Similar walls are symmetrically provided on both sides of the distributor 26. In a particular embodiment, the vertical, horizontal and transversal walls 130,132,136 and the flange 134 on each side are integral with the corresponding side wall 124 and are removable from the distributor 26 in a drawer-like fashion to facilitate maintenance and cleaning. The side wall 124 includes a handle 138 on its outer surface to facilitate the removal thereof, and a locking mechanism 140 to selectively prevent its removal.

Thus, a central chamber 142 is defined between the top wall 116 and the bottom wall 120, bordered by the transversal walls 136 and flanges 134. Four bottom chambers 144 (only two of which are visible in FIG. 7) are defined between the bottom wall 120 and a respective one of the horizontal walls 132, bordered by a respective one of the rear and front walls 118,122, and the vertical wall 130, side wall 124 and flange 134. Four top chambers 146 (only two of which are visible in FIG. 7) are defined between the top wall 116 and a respective one of the horizontal walls 132, bordered by a respective one of the rear and front walls 118,122, and the vertical wall 130, side wall 124 and transversal wall 136. The central chamber 142 is in fluid communication with the inlet 126, and with the four bottom chambers 144 through openings 148 defined by the flanges 134. The four top chambers 146 are in fluid communication with two outlets 128 each, and with a respective one of the bottom chambers 144 through a hole 150 defined in the respective horizontal wall 132, which is centered between the two outlets 128. Such geometry for the distributor 26 favorises an equal distribution of the liquid to reduce the risk of clogging. Of course, the geometry of the distributor 26 is described to accommodate 8 outlets 128, and a different geometry would generally be required for a different number of outlets 128, such that the incoming liquid can be equally and progressively separated between the outlets 128 to avoid clogging.

The flange 134 extending from the bottom wall 120 first ensure and equal distribution of the fluid between the four chambers 144. After the hole 150 prevent the fluid from passing in front of a first outlet 128 which would promote clogging. The holes 150 ensure that the fluid be equally distributed to the outlets 128.

In use, and referring first to FIG. 7, the liquid fertilizer, which can be for example liquid manure or a slurry, is pumped from a reservoir (not shown), enters the central chamber 142 through the inlet 126, then settles before accumulating and pouring over the flanges 134 to fill the bottom chambers 144, slowly coming up through the hole 150 into the top chambers 146, and being equally divided between the two respective outlets 128 on top of each top chamber 146. The path followed by the liquid through the distributor 26 is illustrated by arrow A in FIG. 7.

Referring to FIGS. 5 and 6, the liquid then travels from each outlet 128 through a respective distribution tube 152 (see FIG. 1) to the inlet 86 of the respective second support structure 12. The liquid then travels from the top chamber 104 to the central chamber 106 through the opening 84 in the top wall 41, sliding along the inclined rear wall 94 under the action of gravity. The liquid settles and accumulates at the bottom of the central chamber 106, then overflows through the openings 92 in the side walls 90, thus being divided between the two side chambers 108. The liquid slides down the bottom wall 88 in each side chamber 108 under the action of gravity to exit through the respective outlet 110, sliding on the respective flange 112, and separated by the “V”-shaped bend 114 in two flows, each flow falling just in front and/or over a front portion of its respective knife 16. The path followed by the liquid through the second support structure 14 is illustrated by arrow B in FIGS. 5 and 6.

Thus, the liquid can be distributed either on the ground just before the knife 16 makes an indentation therein, the knife 16 at least partially burying the liquid in the process of making the indentation, or over a front portion of the knife 16 such that the liquid is poured within the indentation as the knife 16 is making it, the action of the knife completing the indentation at least partially burying the liquid.

Accordingly, the combined liquid distributor and soil working tool 10 allows for the liquid fertilizer to be distributed and immediately at least partially buried, thus reducing gaseous emissions of the fertilizer in the atmosphere and as such reducing the surrounding odor. The depth adjustment mechanism formed by the horizontal pivot 46 and interconnected hydraulic cylinders 48 allow for all knives 16 to penetrate the soil at a constant depth, even on uneven ground. The interchangeable knives 16, as well as the individual adjustment of the angle of each group of knives 16 with respect to the travel direction T, through the pivoting shaft 64 and locking handle 68, allows for the soil working tool 10 to be used in variety of applications, with easy and quick adjustment between applications. Of course, the apparatus 10 can be used simply as a soil working tool, by omitting or not using the distributor 26. The distributor 26 and second support structures 14 can also be used to distribute any other type of appropriate product onto the field.

The embodiments of the invention described above are intended to be exemplary. Those skilled in the art will therefore appreciate that the foregoing description is illustrative only, and that various alternatives and modifications can be devised without departing from the spirit of the present invention. Accordingly, the present invention is intended to embrace all such alternatives, modifications and variances which fall within the scope of the appended claims.

I claim:

1. A soil working apparatus comprising: a first structure movable above a soil surface along a travel direction, a plurality of laterally spaced-apart soil working tools distributed along the first structure, at least some of said soil working tools being angularly adjustable relative to said first structure between a first configuration wherein said soil working tools are substantially parallel to one another and a second configuration wherein a series of V-shaped oriented pairs of soil working tools is formed along said first structure, each V-shaped oriented pair of soil working tools defining an apex pointing in one of said direction of travel and a direction opposite thereto.

2. The soil working apparatus according to claim 1, wherein each pair of adjacent soil working tools is angularly adjustable between opposite V-shaped configurations.

3. The soil working apparatus according to claim 1, wherein the soil working tools are mounted to the first structure via a plurality of second structures distributed along the first structure, each second structure carrying at least one soil working tool.

4. The soil working apparatus according to claim 3, wherein irrespectively of a selected angular orientation of said soil working tools, a distance between the at least one soil working tool of one of the second support structures and the at least one soil working tool of an adjacent one of the second support structures is the same along a direction perpendicular to the travel direction.

5. The soil working apparatus according to claim 3, wherein each of said second structures is provided with at least two soil working tools, said at least two soil working tools being angularly adjustable relative to one another on said second structure thereof.

6. The soil working apparatus according to claim 3, wherein each of said second structures carries at least a pair of soil working tools which are rigidly connected together and offset from one another relative to the direction of travel.

7. The soil working apparatus according to claim 3, wherein each of the second structures pivotally supports at least one substantially vertical shaft extending therethrough and supporting at least one of said soil working tools.

8. The soil working apparatus according to claim 7, wherein a handle is rigidly connected to the at least one substantially vertical shaft and is integrally pivotable therewith, the handle having a plurality of spaced apart teeth being selectively engageable with corresponding teeth extending from the second structure to lock the at least one shaft and the at least one of said working tool mounted thereto in a selected angular position with respect to the direction of travel.

9. The soil working apparatus according to claim 3, wherein the at least one soil working tool of each of the second structures forms a first group integrally pivotable about a substantially vertical axis, each of the second structures further supporting a second group of at least one soil working tool integrally pivotable independently from the first group about an additional substantially vertical axis between a plurality of additional angular positions, the apparatus further including a locking mechanism locking the at least one soil working tool of the second group in a selected one of the additional angular positions.

10. The soil working apparatus according to claim 3, wherein each of the at least one soil working tool includes a hub which is rotatably connected to a corresponding one of the second structures such that the at least one soil working tool is rotatable about a central axis of the hub.

11. The soil working apparatus according to claim 3, wherein each of the second structures has at least one chamber defined therein with an inlet for receiving a liquid and at least one outlet in proximity of the at least one soil working tool, the at least one outlet being in fluid communication with the inlet through the at least one chamber and distributing the liquid on the soil surface in proximity of the at least one soil working tool.

12. The soil working apparatus according to claim 3, wherein each of the second structures is pivotally connected to the first structure to be selectively and independently pivotable about a respective substantially horizontal axis to vary a depth of penetration of the at least one soil working tool within the soil surface.

13. The soil working apparatus according to claim 12, further comprising means for forcing a pivoting motion of each of the second structures about the respective substantially horizontal axis in a direction pressing the at least one soil working tool against the soil surface with a given pressure, the given pressure being similar for all of the second structures such that the depth of penetration is substantially the same for the at least one soil working tool of all of the second structures.

14. The soil working apparatus according to claim 3, wherein each of the second structures removably supports the at least one soil working tool such that each of the at least one soil working tool is interchangeable with a different soil working tool selected according to a type of work to be done on the soil surface with the tool.

15. A soil working apparatus comprising:
a first structure moveable above a soil surface along a travel direction; and
a plurality of second structures, each second structure supporting at least one soil working tool penetrating the soil surface and adapted to be dragged therein along the travel direction upon movement of the first structure along the travel direction, each of the second structures being pivotally connected to the first structure to be independently pivotable about a respective substantially horizontal axis to vary a depth of penetration of the at least one soil working tool within the soil surface.

16. The soil working apparatus according to claim 15, further comprising means for forcing a pivoting motion of each of the second structures about the respective substantially horizontal axis in a direction pressing the at least one soil working tool against the soil surface with a given pressure, the given pressure being similar for all of the second structures such that the depth of penetration is substantially the same for the at least one soil working tool of all of the second structures.

17. The soil working apparatus according to claim 16, wherein the means include a plurality of hydraulic cylinders, one of the hydraulic cylinders being provided between each of the second structures and the first structure such that an increase in hydraulic fluid pressure forces the pivoting motion of the respective second structure in the direction pressing the at least one soil working tool against the soil surface, the hydraulic cylinders being in serial fluid communication with one another such that the hydraulic fluid pressure is the same for all the hydraulic cylinders.

18. The soil working apparatus according to claim 15, wherein each of the second structures is also pivotally connected to the first structure to be independently pivotable about a respective substantially vertical axis, the apparatus further comprising removable means for selectively preventing each of the second structures from pivoting about the respective substantially vertical axis.

19. The soil working apparatus according to claim 18, wherein the means include a removable articulated rod interconnecting a respective one of the second structures to the first structure, preventing the respective one of the second structures from pivoting about the substantially vertical axis and being articulated to allow the respective one of the second structures to pivot about the substantially horizontal axis.

20. A combined soil working tool and fluid distributor comprising:
a frame moveable above a ground surface along a travel direction; and
a plurality of hollow supports connected to the frame, each of the supports carrying at least one soil working tool extending downwardly therefrom and adapted to penetrate the ground surface to create a trench therein upon movement of the frame along the travel direction, each of the hollow supports defining at least one chamber, an inlet in fluid communication with the at least one chamber, and at least one outlet in proximity of the at least one soil working tool, each of the at least one outlet being in fluid communication with a respective one of the at least one chamber, the inlet receiving a flowable product to be distributed over the ground from a source of flowable product, the at least one chamber circulating the flowable product between the inlet and the at least one outlet, and the at least one outlet distributing the liquid substantially at ground level in proximity to said at least soil working tool, the at least one soil working tool burying at least partially the flowable material beneath the ground surface upon creating the trench.

21. The combined soil working tool and fluid distributor according to claim 20, wherein the inlet is defined in a top portion of the support, the at least one outlet is defined in a bottom portion of the support, and the at least one chamber directs the flowable product between the inlet and the at least one outlet under the action of gravity.

22. The combined soil working tool and fluid distributor according to claim 20, wherein for each of the supports the at least one soil working tool includes first and second spaced apart groups of at least one soil working tool, the at least one outlet includes first and second outlets respectively defined in proximity and upstream of the first and second groups, and the at least one chamber includes first and second chambers in fluid communication with a central chamber which is in turn in fluid flow communication with the inlet, the first and second chamber being respectively in fluid flow communication with the first and second outlets, the flowable product received through the inlet being substantially equally divided between the first and second chambers by weir-like ridges provided at the bottom of the central chamber between the central chamber and the first and second chambers.

23. The combined soil working tool and fluid distributor according to claim 20, wherein a distribution box is provided for equally dividing the flow of flowable product to the hollow supports, the distribution box comprising a central chamber having an inlet, said central chamber being connected in fluid flow communication with at least two secondary chambers, and wherein overflow members extend upwardly from a bottom of said central chamber between said central chamber and said secondary chambers, said secondary chambers being each provided with at least one outlet connected in fluid flow communication with an associated one of said hollow supports.

24. A method of distributing a liquid on a field, the method including the steps of:
dragging a soil working tool penetrating a ground surface of the field along a travel direction to form a trench;
while dragging the soil working tool, distributing the liquid on the ground surface one of directly in front of the soil working tool and substantially over a front portion of the soil working tool, the soil working tool at least partially burying the liquid beneath the ground surface as the trench is formed.

25. The method according to claim 24, wherein before distributing the liquid on the ground surface, the liquid is circulated within a support structure supporting the soil working tool.

26. The method according to claim 25, wherein before circulating the liquid within the support structure, the liquid is substantially equally divided by a distributor between the support structure and additional similar support structures each supporting at least one additional soil working tool being dragged to form a respective additional trench.
